(19) United States
(12) Patent Application Publication
(10) Pub. No.: US 2026/0340628 A1
(43) Pub. Date: Oct. 29, 2026

(54) SYSTEMS AND METHODS FOR DYNAMICALLY GENERATING CRYPTOGRAPHIC DATA ELEMENTS IN TRANSACTIONS

(71) Applicant: Mastercard International Incorporated, Purchase, NY (US)

(72) Inventors: Sachin Bakshi, Pune (IN); Vineeth Vijayan, Chennai (IN)

(73) Assignee: Mastercard International Incorporated, Purchase, NY (US)

(21) Appl. No.: 19/192,552

(22) Filed: Apr. 29, 2025

(51) Int. Cl. G06Q 20/38; G06Q 20/20; G06Q 20/40; H04L 9/06

(52) U.S. Cl. CPC G06Q 20/3829; G06Q 20/202; G06Q 20/401; H04L 9/0631

(57) ABSTRACT

Systems and methods employ a cryptographic data element (CDE) for generating an authorization request cryptogram (ARQC) without relying on a conventional Application Transaction Counter (ATC). A payment device with a master key and a secure device identifier (ID) receives transaction data from a point-of-sale (POS) terminal, including an epoch timestamp and a terminal ID. The payment device generating a representation of the epoch timestamp, the terminal ID, and the device ID into a numeric block and encrypts the block to produce the CDE. A session key is derived from the CDE, and an AES-based cryptographic process is applied to generate the ARQC. The ARQC is transmitted to the POS terminal.

### BACKGROUND

The present disclosure relates to systems and methods for secure electronic payment processing, and in particular, to generating dynamic cryptographic data elements in EMV-based card transactions.

In existing EMV-based payment systems, an application transaction counter (ATC) is typically incremented for each card-present transaction and validated by the issuer to detect fraud and manage transaction sequence. Because the issuer or payment network must store, update, and compare ATCs for every individual card in real time, extensive database infrastructure is needed to handle this rapidly growing set of values. Transaction processing times can vary across different channels, so the system often tracks a range of possible valid ATCs for any given card, further burdening these databases and introducing additional complexity. Moreover, replay and out-of-range attacks must be mitigated by verifying whether an ATC has already been used or lies outside an expected boundary, which can exacerbate latency issues and significantly increase resource consumption.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a computer-implemented method for generating an application request cryptogram (ARQC) for use in a transaction is provided. The method is performed by a specialized cryptographic payment device. The payment device includes a cryptographic coprocessor and a secure memory. The secure memory stores at least a master key and a device identifier uniquely identifying the payment device. The method includes receiving, from a point-of-sale (POS) terminal, a request message requesting generation of the ARQC. The request message includes transaction data associated with the transaction, a timestamp, and a terminal identifier associated with the POS terminal and uniquely identifying the POS terminal. The method includes retrieving, from the secure memory, the device identifier. The method also includes forming a data block by generating a representation of the timestamp, the terminal identifier, and the device identifier. Furthermore, the method includes encrypting, by the cryptographic coprocessor, the data block using the master key, thereby producing a cryptographic data element (CDE). Additionally, the method includes deriving a session key from the CDE. The method also includes generating the ARQC, including (i) forming a transaction data string by generating a representation of the transaction data and the CDE, and (ii) encrypting, by the cryptographic coprocessor, the transaction data string using the session key. Moreover, the method includes transmitting the ARQC and the CDE to the POS terminal for transmission to an issuer server associated with the payment device for validation.

In another aspect, a specialized cryptographic payment device for generating an application request cryptogram (ARQC) for use in a transaction is provided. The payment device includes a first processor, a second cryptographic coprocessor, a first secure memory storing a master key and a device identifier uniquely identifying the payment device, and a second program memory storing computer executable instructions thereon. The instructions, when executed by the first processor, cause the first processor to receive, from a point-of-sale (POS) terminal, a request message requesting generation of the ARQC. The request message includes transaction data associated with the transaction, a timestamp, and a terminal identifier associated with the POS terminal and uniquely identifying the POS terminal. The processor retrieves the device identifier from the first secure memory. The processor forms a data block by generating a representation of the timestamp, the terminal identifier, and the device identifier. The processor also engages the second cryptographic coprocessor, and encrypts, via the second cryptographic coprocessor, the data block with the master key, thereby producing a cryptographic data element (CDE). The processor derives a session key from the CDE. In addition, the processor generates the ARQC, including (i) forming a transaction data string by generating a representation of the transaction data and the CDE, and (ii) encrypting, via the second cryptographic coprocessor, the transaction data string using the session key. Furthermore, the processor transmits the ARQC and the CDE from the payment device to an issuer server associated with the payment device for validation.

A variety of additional aspects will be set forth in the detailed description that follows. These aspects can relate to individual features and to combinations of features. The advantages of these and other aspects will be apparent to those skilled in the art from the following description of the exemplary embodiments which have been shown and described by way of illustration. As will be realized, the details of the present aspects described herein may be modified in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram illustrating an example multi-party transaction card network system, in accordance with one or more embodiments of the present disclosure;

FIG. 2 is a block diagram of a transaction card account system showing data flow among a transaction card, a merchant processor, a payment processor, and an issuer processor;

FIG. 3 is a schematic front view of a transaction card shown in FIG. 2;

FIG. 4 is a block diagram of a micromodule included in the transaction card of FIG. 3, illustrating a memory device, processor, cryptographic coprocessor, and related components;

FIG. 5 is an example configuration of a merchant point-of-sale (POS) terminal, which may be used by a merchant as shown in FIG. 1;

FIG. 6 is an example configuration of a server system, such as an issuer processor depicted in FIG. 2;

FIG. 7 is a flowchart illustrating an exemplary computer-implemented method for deriving an integrated circuit card (ICC) master key from an issuer master key and provisioning the ICC master key onto a transaction card;

FIG. 8 is a flowchart illustrating an exemplary computer-implemented method for performing a secure transaction between the transaction card and the POS terminal using a dynamic cryptographic data element; and

FIG. 9 is a flowchart illustrating an exemplary computer-implemented method for securely validating a transaction by verifying an authorization request cryptogram using the dynamic cryptographic data element.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

Systems and methods of the present disclosure utilize a dynamic cryptographic data element (CDE) that replaces the standard ATC used in online EMV transactions. Rather than incrementing a counter, the payment device (such as an EMV transaction card or payment device with a digital wallet) obtains a real-time epoch timestamp from the transacting point-of-sale (POS) terminal, appends its unique device identifier, and further appends the unique terminal identifier. The payment device encrypts the data string with the integrated circuit card (ICC) master key of the payment device. By employing a real-time timestamp, the disclosed approach ensures that each transaction CDE is unique without requiring a centralized database that tracks current or prior counts. The issuer, upon receiving the encrypted data from the acquirer, decrypts the CDE, retrieves the timestamp, and checks how recently the transaction was initiated, thereby validating both recency and device identity. Because the approach forgoes the need to store or increment counters, there is no reliance on a persistent ATC value and the required infrastructure.

At least one technical problem addressed by the systems and methods described herein is as follows: Conventional EMV-based payment systems rely on an increment-only Application Transaction Counter (ATC), which necessitates continuous storage and synchronization of ATC values across multiple online endpoints. This introduces latency in transaction processing, demands substantial infrastructure, and complicates fraud checks due to the need for real-time database updates and replay-attack detection. This results in, among other negative effects, reduced scalability, increased risk of inconsistencies, and a performance bottleneck due to the persistent overhead of ATC maintenance, impacting security and overall system complexity.

The technical effects described herein provide the technical advantage of eliminating the incremental ATC, which obviates extensive database operations and reduces the time spent validating whether an ATC is correct or duplicated, thereby improving transaction-processing speed. Tying the cryptographic data to a real-time timestamp further mitigates replay attacks, since an attacker cannot simply re-send a valid cryptogram from an earlier transaction without failing the time-difference check. By shifting from a counter-based model to a time-based CDE, the system gains scalability because the system no longer requires distributed ATC synchronization or lookups that become prohibitive under high load. Additionally, because the invention leverages standard POS terminals for timestamp retrieval and a secure payment card for the actual encryption, it is compatible with existing EMV infrastructure and can be implemented while focusing on AES or similar symmetric encryption methods.

### Exemplary Payment Network Systems

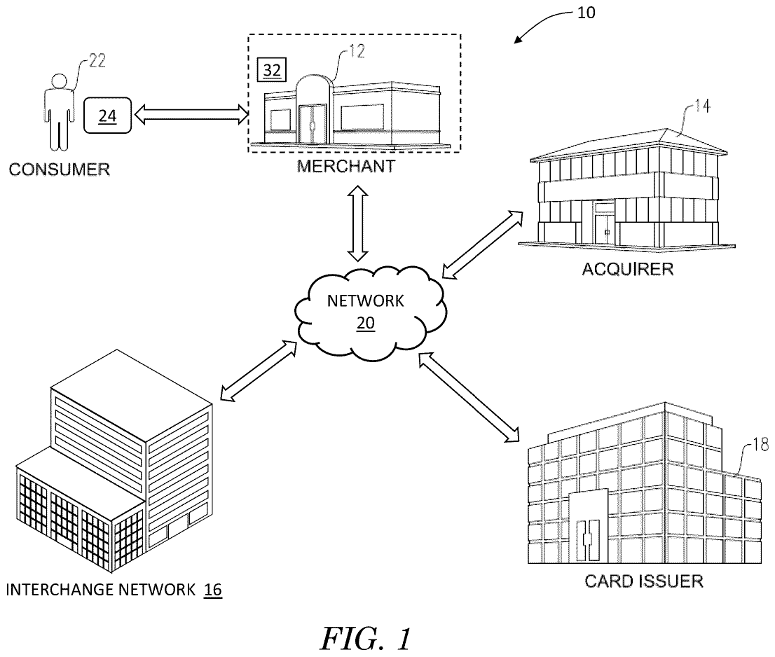

FIG. 1 is a block diagram illustrating an example multi-party transaction card network system 10, in accordance with one or more embodiments of the present disclosure. The example transaction card network system 10 generally includes a merchant 12, an acquirer 14, an interchange network 16, and a card issuer 18, coupled in communication via a network 20. As used herein, the term “interchange network” includes an electronic network that exchanges data relating to the value of card sales and credits among the card issuers 18 and the acquirers 14.

The transaction card network system 10 facilitates providing interchange network services offered by the interchange network 16. In addition, the transaction card network system 10 enables payment card-based transactions in which the merchants 12, the acquirers 14, and/or the card issuers 18 do not need to have a one-to-one relationship. As an example, the transaction card network system 10 may be utilized by the merchants 12 as part of a process of initiating a pre-authorization request for performing a transaction (as described herein). Although parts of the transaction card network system 10 are presented in one arrangement, other embodiments may include the same or different parts arranged otherwise, depending, for example, on pre-authorization processes for purchase transactions, communication between computing devices, etc.

The network 20 includes, for example and without limitation, one or more of a local area network (LAN), a wide area network (WAN) (e.g., the Internet), a mobile network, a virtual network, and/or any other suitable public and/or private network capable of facilitating communication among the merchants 12, the acquirers 14, the interchange network 16, the issuers 18, and/or a consumer or cardholder 22 (also referred to herein as a “user”). Additionally, the network 20 may include more than one type of network, such as a private payment transaction network provided by the interchange network 16 to the acquirers 14 and/or the card issuers 18, and separately, the public Internet, which may facilitate communication between the merchants 12, the interchange network 16, the acquirers 14, and/or the cardholders 22.

Embodiments described herein relate to a transaction card system, such as a credit card payment system using the Mastercard® interchange network. (Mastercard is a registered trademark of Mastercard International Incorporated.) The Mastercard interchange network is a set of proprietary communications standards promulgated by Mastercard for the exchange of financial transaction data and the settlement of funds between financial institutions that are members of Mastercard. As used herein, financial transaction data includes a unique account number associated with an account holder using a transaction card issued by a card issuer, purchase data representing a purchase made by the consumer (including a type of merchant, amount of purchase, date of purchase, and other data), which may be transmitted between any parties of the multi-party transaction card network system 10.

In a typical transaction card system, a financial institution called the “issuer” issues a payment device (e.g., a debit card, credit card, or the like) to the user or cardholder 22. The cardholder 22 uses the transaction card 24 to tender payment for a purchase from the merchant 12. The merchant 12 is typically associated with products—goods and/or services—that are offered for sale and are sold to the cardholders 22. The merchant 12 includes, for example, a physical location and/or a virtual location. A physical location includes, for example, a brick-and-mortar store, etc., and a virtual location includes, for example, an Internet-based storefront.

To accept payment with the transaction card 24, the merchant 12 must normally establish an account with a financial institution that is part of the transaction card network system 10. This financial institution is usually called the “merchant bank,” the “acquiring bank,” or the acquirer 14.

When the cardholder 22 provides payment for a purchase with the transaction card 24, the merchant 12 requests authorization from the acquirer 14 for the purchase amount. The request may be performed over the telephone but is usually performed using a point-of-sale (POS) terminal, such as a POS terminal 32, that reads the consumer's account information from a magnetic stripe, a chip, or embossed characters on the transaction card 24, and communicates electronically with the transaction processing computers of the acquirer 14. In the example embodiment of an EMV (Europay, Mastercard, and Visa) based transaction, the transaction card 24 generates an authorization request cryptogram (ARQC) using an integrated circuit card master key. The POS terminal 32 collects the ARQC and other relevant card data from the transaction card 24 and transmits this information to the acquirer 14. In some embodiments, the acquirer 14 may authorize a third party (not shown) to perform transaction processing on its behalf. In this case, the POS terminal 32 will be configured to communicate with the third party. Such a third party is usually called a “merchant processor,” an “acquiring processor,” or a “third party processor.”

Using the interchange network 16, computers of the acquirer 14 or merchant processor will communicate with computers of the card issuer 18 to determine whether the cardholder's account is in good standing and whether the purchase is covered by the cardholder's available credit line or account balance. The acquirer 14 transmits the transaction details to the interchange network 16, which forwards the transaction details to the issuer 18. In the example EMV-based transaction, the issuer 18 validates the ARQC and performs additional fraud checks. Based on a determination regarding the cardholder's account standing and funds availability, the request for authorization will be declined or accepted, and an authorization request response is transmitted by the card issuer 18 to the interchange network 16, which forwards the response to the acquirer 14 and then to the merchant 12/POS terminal 32. The POS terminal 32 updates the transaction card 24 with the final transaction status.

When a request for authorization is accepted, the available funds or a credit line of the cardholder's account is decreased. Normally, a charge for a transaction card transaction is not posted immediately to the cardholder's account because bankcard associations, such as the association operating under or in connection with the Mastercard® mark, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on the POS terminal 32. This may include bundling of approved transactions daily for standard retail purchases. If the cardholder 22 cancels a transaction before it is captured, a “void” is generated. If the cardholder 22 returns goods after the transaction has been captured, a “credit” is generated. The interchange network 16 and/or the card issuer 18 stores the transaction data, such as, and without limitation, the primary account number (PAN) and expiry date of the transaction card, a type of merchant, a merchant identifier, a location where the transaction was performed, a dollar amount of the transaction, a merchant category code, a date and time of the transaction, products purchased and related descriptions or identifiers, etc., in a transaction database (not shown).

After the transaction has been authorized, the transaction is cleared and settled among the parties to the transaction, such as the acquirer 14 and the card issuer 18. Clearing refers to the communication of financial data for reconciliation purposes between the parties. Settlement refers to the transfer of funds between the merchant's account, the acquirer 14, and the card issuer 18 associated with the transaction.

While only one merchant 12, acquirer 14, interchange network 16, and card issuer 18 are shown in FIG. 1 (for ease of reference), it should be appreciated that a variety of other embodiments may include multiple ones of these parts in various combinations. In practice, multiple acquirers, multiple card issuers, and multiple merchants can simultaneously utilize the interchange network 16 for numerous concurrent EMV-based transactions involving ARQCs and the corresponding validation processes described above.

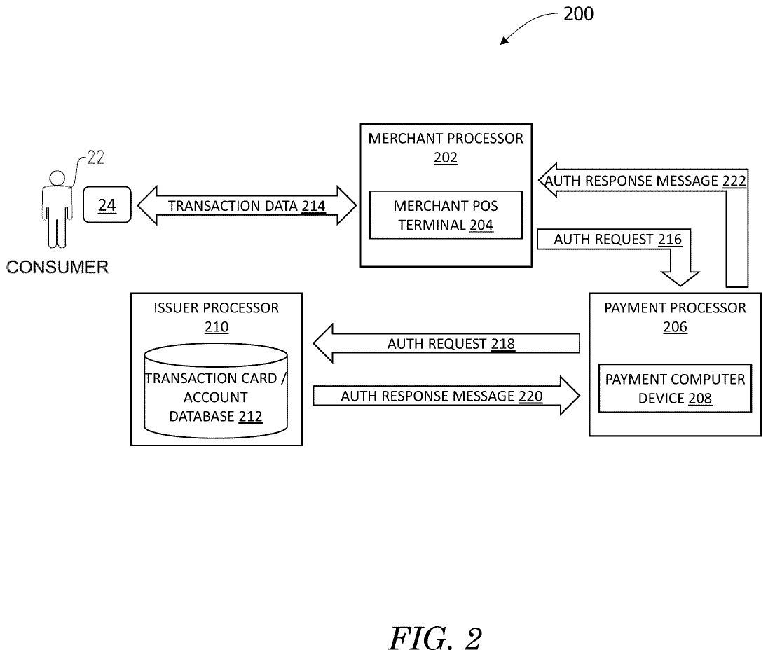

FIG. 2 is a block diagram of a transaction card account system 200 showing data flow among the transaction card 24, a merchant processor 202 (or merchant server), a payment processor 206, and an issuer processor 210 (or issuer server). In the example embodiment, the system 200 is a transaction card account system such as the transaction card network system 10 (shown in FIG. 1). In some embodiments, the payment processor 206 is an interchange network, such as the interchange network 16 (shown in FIG. 1). The transaction card 24 is configured to allow the cardholder 22 to access the merchant processor 202, for example, via a merchant POS terminal 204, which is a point-of-sale (POS) device such as the POS terminal 32 (shown in FIG. 1). The transaction card 24 can be used to purchase goods and/or services associated with a merchant, such as the merchant 12 (shown in FIG. 1). In the example embodiment, the transaction card 24 is capable of being operably coupled with the merchant POS terminal 204 (as described herein).

In the example embodiment, the merchant processor 202 includes the merchant POS terminal 204. As described, the merchant POS terminal 204 is a computer device such as the POS terminal 32. The merchant POS terminal 204 is a service-provided device that is coupled in communication with the merchant processor 202. In the exemplary embodiment, when performing a transaction, the transaction card 24 establishes communication with the merchant POS terminal 204, for example, via an integrated chip or wirelessly via near field communication (NFC) enabled circuitry.

The merchant POS terminal 204 obtains the current epoch timestamp (i.e., the number of seconds elapsed from 00:00:00 UTC on Jan. 1, 1970) and a POS terminal identifier (ID). The POS terminal ID is a unique identifier assigned to the POS terminal 32 to identify the specific POS terminal. The merchant POS terminal 204 transmits the epoch timestamp and terminal ID to the transaction card 24 (or other payment device, such as a digital wallet device (not shown)).

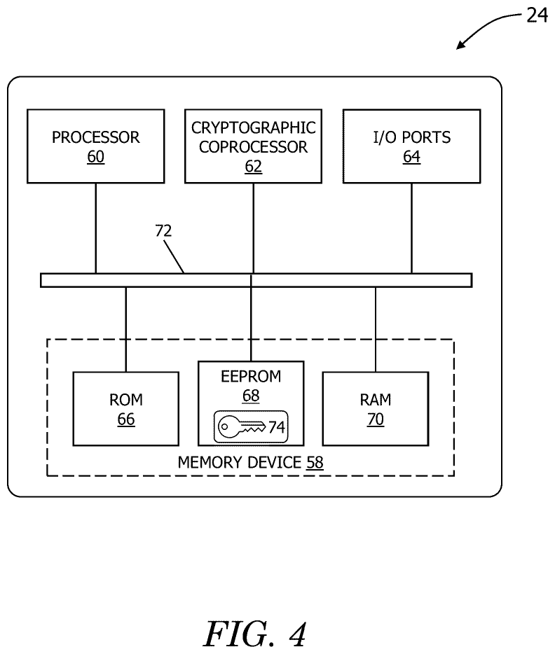

The transaction card 24 retrieves its device identifier (ID), such as a unique hardware identifier assigned by the chip manufacturer. The transaction card 24 combines (1) the epoch timestamp, (2) the terminal ID, and (3) the device ID. The transaction card 24 then applies an AES (Advanced Encryption Standard) encryption to the combined value using its integrated circuit card master key (see FIG. 4, ICC master key 74) stored on the chip. In embodiments utilizing a payment device with a digital wallet, the payment device may use a derived application cryptogram key (AC key) for encrypting the data. In the example, the combination and encryption process creates a new dynamic CDE. The CDE replaces the conventional application transaction counter (ATC). Unlike the standard ATC, which increments by a single count per transaction, the CDE is dynamically generated from the epoch timestamp, terminal ID, and device ID, thereby providing collision-resistant, per-transaction uniqueness without requiring a data store for ATC synchronization. Furthermore, the issuer 18 can decrypt and validate the CDE—based on the timestamp embedded therein—to detect potential fraud by verifying whether the transaction time is within an allowable tolerance. This approach strengthens transaction security by tying the cryptographic data to the unique payment device, the unique POS terminal, and the precise transaction time.

The transaction card 24 uses the CDE to generate the authorization request cryptogram (ARQC), as described further herein. The transaction card 24 transmits transaction data 214 to the merchant POS terminal 204 when making a purchase from the merchant 12. The transaction card 24 is configured to transmit the transaction data 214 via, for example, an integrated chip or wirelessly via near field communication (NFC) enabled circuitry, to the merchant POS terminal 204. The transaction data 214 may include, for example, transaction information that identifies the card issuing bank (i.e., the issuer 18), a transaction amount, a transaction date and time, the ARQC, the CDE, and a card verification method (CVV).

The merchant processor 202 receives the transaction data 214 and generates a payment authorization request message 216. The payment authorization request message 216 is transmitted to the payment computer device 208 for processing and further transmission to an issuing bank for approval (shown as payment authorization request message 218). In one or more embodiments, the payment computer device 208 includes an interchange computer associated with an interchange, such as the interchange network 16.

The issuer processor 210 receives the payment authorization request message 218 and retrieves financial account data associated with the financial account referenced by the transaction card 24, for example, from a transaction card/account database 212. The issuer processor 210 transmits an authorization request response message 220 to the payment computer device 208, which forwards the authorization request response message to the merchant processor 202 (shown as authorization request response message 222). Based on the details included in the authorization request response message 222, the merchant POS terminal 204 may, for example, and without limitation, complete the transaction.

### Exemplary Transaction Card

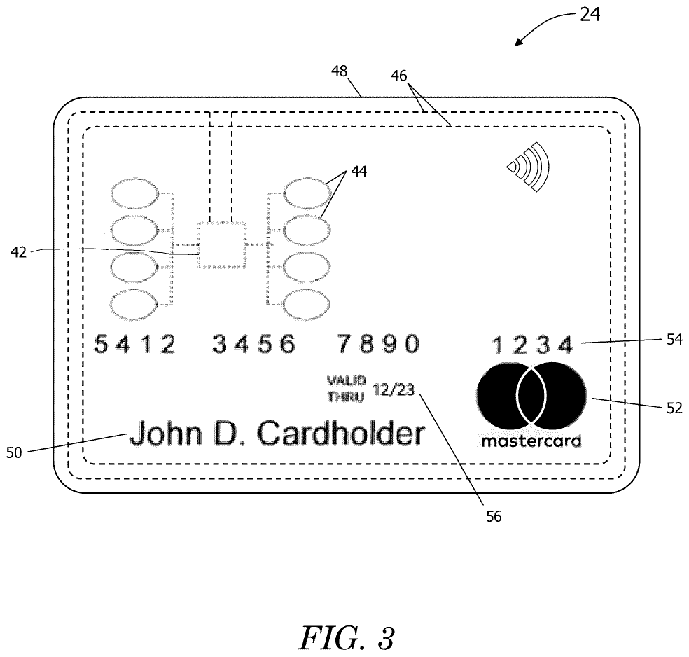

FIG. 3 is a schematic front view of the transaction card 24. In the exemplary embodiment, the transaction card 24 includes an embedded integrated circuit (IC) or micromodule 42 that stores and transmits data between electronic devices. The micromodule 42 includes a silicon IC chip with a memory device 58 (shown in FIG. 4) and a processor 60 (shown in FIG. 4). Alternatively, in some embodiments, the micromodule 42 may only include memory with non-programmable logic. In the exemplary embodiment, the transaction data stored on the micromodule 42 is associated with at least one payment account linked to a funding source, such as a consumer deposit account (not shown). As described herein, the data includes payment account information such as the PAN, a sequence number, and an expiry date, among other data, of the transaction card 24. In the exemplary embodiment, the transaction card 24 may be configured as a credit card, a debit card, and/or a stored value card (i.e., a payment card containing monetary value that can be transferred when a cardholder performs a payment transaction).

As shown in FIG. 3, the micromodule 42 includes a plurality of electrical contacts 44 for communication between the transaction card 24 and the POS terminal 32 (shown in FIG. 1). In addition, in some embodiments, the transaction card 24 includes an antenna 46, which is provided for contactless communication, such as, for example, NFC. For example, in such an embodiment, the antenna 46 generates a magnetic field when it vibrates at a selected frequency. Specifically, the antenna 46 is configured to vibrate at a frequency of about 13.56 MHz, which is suitable for use in an NFC system.

The antenna 46 transmits radio signals to and receives radio signals from other NFC-enabled computing devices, for example, the merchant POS terminal 32, and/or any other components used in NFC systems. In NFC systems, at least one NFC component generates a magnetic field to inductively transfer currents and, thereby, exchange signals and information with other NFC components positioned within the magnetic field. In the exemplary embodiment, the antenna 46 functions as an NFC component to send and receive signals. The antenna 46 is configured to transmit radio signals to NFC components positioned within the magnetic field of the antenna 46, such as when the POS terminal 32 is located within a predetermined distance of the transaction card 24. As such, the antenna 46 sends and receives radio signals from NFC components when the antenna 46 is positioned within the magnetic field of the NFC components. Accordingly, the micromodule 42 includes a radio frequency (RF) interface, an NFC device controller, and other NFC-enabled circuitry (not shown) to facilitate enabling NFC communication on the transaction card 24. The RF interface is configured to receive and transmit RF signals through the antenna 46. The NFC device controller is configured to process the received RF signals and to generate signals to be transmitted by the RF interface. The memory device 58 is configured to store data associated with transmitting and receiving the RF signals. Furthermore, the NFC device controller is coupled in communication with the processor 60.

The processor 60 contains control logic, input/output ports, etc. to enable the micromodule 42 to operate. While not described herein, it is noted that a person skilled in the art of chip and/or contactless cards will be familiar with the necessary specifications, such as Mastercard contactless specifications, available under license from the association operating under or in connection with the Mastercard® mark.

The transaction card 24 includes a laminated body 48, which houses the micromodule 42 and antenna 46. In addition, the transaction card 24 includes a consumer's name 50 and a logo 52 of a financial company whose services are used by the cardholder. Moreover, the transaction card 24 includes the PAN 54 and an expiration date 56. The PAN 54 corresponds to the consumer's financial account, which is generally held by the card issuer 18. The name 50, logo 52, PAN 54, and expiration date 56 may be printed on the front surface, the back surface, and/or in any combination of the front and back surface of the laminated body 48.

FIG. 4 is a block diagram of the micromodule 42. In the exemplary embodiment, the micromodule 42 includes a system bus 72 linking the memory device 58, the processor 60, a cryptographic coprocessor 62, and input/output buffers 64 together in communication. Control logic for the processor 60 is configured to provide control for handling communications between the memory device 58 and the input/output buffers 64. The cryptographic coprocessor 62 includes a dedicated hardware module for performing encryption and decryption operations to secure sensitive data. The input/output buffers 64 include circuits that interface with the POS terminal 32 (shown in FIG. 1), managing data transmission between the micromodule 42 and the POS terminal's contact pads.

The memory device 58 includes different types of memory, such as volatile and non-volatile memory, and read-only and programmable memory. For example, as shown in FIG. 4, the memory device 58 includes a program memory or read-only memory (ROM) 66 (typically storing instructions for the processor 60), a secure memory or electrically erasable programmable read-only memory (EEPROM) 68, and random-access memory (RAM) 70. In the exemplary embodiment, the EEPROM 68 stores sensitive data like account number, expiry date, the device ID of the transaction card, and one or more cryptographic keys, such as the ICC master key 74. The RAM 70 may be used for working/temporary data storage during transaction processing.

### Exemplary Computer Systems

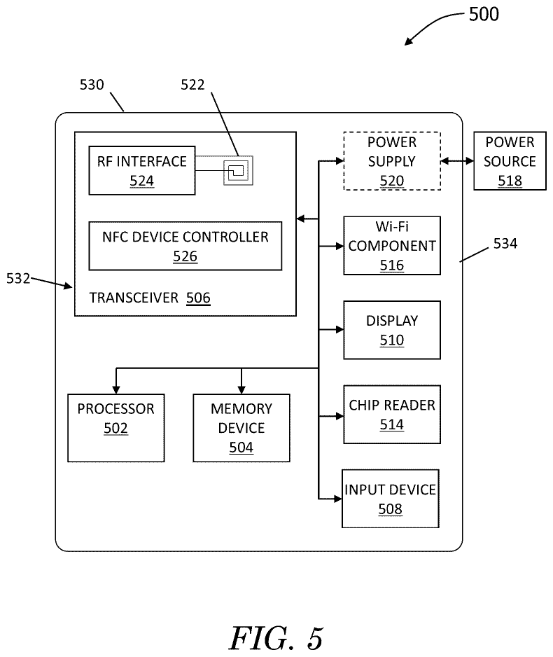

FIG. 5 is an example configuration of a merchant point-of-sale (POS) terminal 500 that may be used by a merchant, such as the merchant 12 (shown in FIG. 1). In some embodiments, the POS terminal 500 is the POS terminal 32 (shown in FIG. 1). In the example embodiment, the POS terminal 500 is a computing device configured to read and/or write to the transaction card 24 (shown in FIG. 2) and to communicate with one or more of the acquirer 14, the interchange network 16, the card issuer 18 (all shown in FIG. 1), and/or other computing devices (not shown).

In the exemplary embodiment, the POS terminal 500 generally includes a processor 502, a memory device 504, a transceiver 506 (e.g., a wireless communication device), an input device 508, a display 510, and a chip card reader 514. In addition, in some embodiments, the POS terminal 500 includes an integrated Wi-Fi component 516 (e.g., implementing the Institute of Electrical and Electronics/IEEE 802.11 family of standards). The POS terminal 500 may include an external power source 518 to receive power, or alternatively, in some embodiments, the POS terminal 500 may include an internal power supply 520 (e.g., a battery or other self-contained power source).

The processor 502 includes one or more processing units (e.g., in a multi-core configuration) specially programmed for executing computer readable instructions. The instructions may be executed within a variety of different operating systems (OS) on the POS terminal 500, such as UNIX, LINUX, Microsoft Windows®, etc. More specifically, the instructions may cause various data manipulations on data stored in the memory device 504 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages). The memory device 504 is any device allowing information, the executable instructions, and/or written works to be stored and retrieved. The memory device 504 includes one or more computer readable media.

In the example embodiment, the processor 502 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

Because the POS terminal 500 may be widely deployed, it may be impractical to manually update software for each POS terminal 500. Therefore, the system 10 (shown in FIG. 1) provides a mechanism for automatically updating the software on the POS terminal 500. For example, an updating mechanism may be used to automatically update any number of components and their drivers, both network and non-network components, including system level (OS) software components. In some embodiments, the POS terminal 500 components are dynamically loadable and unloadable; thus, they may be replaced in operation without having to reboot the OS.

Stored in the memory device 504 are, for example, computer readable instructions for providing a user interface to the user via the display 510 and, optionally, receiving and processing input from the input device 508. A user interface may include, among other possibilities, a payment application. A payment application allows the cardholder 22 (shown in FIG. 1) to interact with the POS terminal 500 to transmit transaction information related to the customer's purchase and financial account.

In the example embodiment, the display 510 can include, for example, and without limitation, a liquid crystal display (LCD), an organic light emitting diode (OLED) display, an “electronic ink” display, and the like. In some embodiments, a single component such as a touch screen may function as both an output device (e.g., the display 510) and the input device 508. As such, the display 510 may optionally include a touch controller for support of touch capability. In such embodiments, the POS terminal 500 may detect a person's presence by detecting that the person has touched the display 510 of the POS terminal 500.

In one or more embodiments, the transceiver 506 includes an antenna 522. The antenna 522 includes a looped wire configured to transmit radio signals when current flows through the looped wire. The antenna 522 is any size, shape, and configuration that is suitable for transmitting signals as described herein. For example, the antenna 522 is a tuned circuit configured to transmit radio signals in any radio-based communication system including, but not limited to, Radio Frequency Identification (RFID), Wireless Local Area Network (WLAN), and Wireless Personal Area Network (WPAN) systems. In the example embodiment, the antenna 522 generates a magnetic field when it vibrates at a selected frequency. Specifically, the antenna 522 is configured to vibrate at a frequency of about 13.56 MHz, which is suitable for use in an NFC system.

In the example embodiment, the antenna 522 transmits radio signals to and receives radio signals from other NFC-enabled computing devices, for example, the transaction card 24 (shown in FIG. 3) or any other components used in NFC systems. In NFC systems, at least one NFC component generates a magnetic field to inductively transfer currents and, thereby, exchange signals and information with other NFC components positioned within the magnetic field. In the exemplary embodiment, the antenna 522 functions as an NFC component to send and receive signals. The antenna 522 is configured to transmit radio signals to NFC components positioned within the magnetic field of the antenna 522, such as when the transaction card 24 is located within a predetermined distance of the POS terminal 500. Therefore, the magnetic field generated by the antenna 522 defines the active range of the POS terminal 500. Additionally, the antenna 522 receives radio signals from NFC components when the antenna 522 is positioned within the magnetic field of the NFC components.

The transceiver 506 also includes a radio frequency (RF) interface 524 and an NFC device controller 526. The RF interface 524 and the NFC device controller 526 are powered by the power source 518, and in some embodiments, the internal power supply 520 and/or the display 510. In addition, the processor 502 and the memory device 504 are powered in the same manner. The RF interface 524 is configured to receive and transmit RF signals through the antenna 522. The NFC device controller 526 is configured to process the received RF signals and to generate signals to be transmitted by the RF interface 524. The memory device 504 is configured to store data associated with transmitting and receiving the RF signals. The NFC device controller 526 is coupled in communication with the processor 502.

In the exemplary embodiment, the transceiver 506 is configured for reading transaction card account data from the transaction card 24, and in particular, from the micromodule 42 (shown in FIG. 3), to conduct a purchase transaction. In addition, in certain embodiments, the transceiver 506 is also configured for writing various data to the transaction card 24, and in particular, to the micromodule 42. The antenna 522 enables the POS device 500 to transmit data signals to the transaction card 24. For example, the POS device 500 may transmit a terminal ID and a timestamp to the transaction card 24 during a transaction.

In the example embodiment, the chip reader 514 is configured for reading transaction card account data from the transaction card 24, and in particular, from the micromodule 42 (shown in FIG. 3), to conduct a purchase transaction. The chip reader 514 includes components (not shown) for contacting one or more of the electrical contacts 44 and reading the digital data stored in the memory device 58. In addition, in certain embodiments, the chip reader 514 is also configured for writing various data to the transaction card 24, and in particular, to the micromodule 42. The components for contacting one or more of the electrical contacts 44 enable the POS device 500 to write data to the memory device 58, and in particular, the RAM 70.

In the example embodiment, the POS terminal 500 includes a housing 530 at least partly (and more preferably, at least substantially or entirely) enclosing the components described above. In addition, the POS terminal 500 includes circuitry 532 configured to communicate with the transaction card 24. The circuitry 532 may include, for example, leads, connectors, NFC-enabled circuitry, Wi-Fi-enabled circuitry, and the like. The housing 530 is preferably configured to seal the circuitry 532, which is susceptible to degradation from the ambient environment. In one or more embodiments, the circuitry 532 is hermetically sealed in the housing 530. For example, in one or more embodiments, the circuitry 532 is completely and permanently encased within the housing 530. In other words, the housing 530 and the circuitry 532 are intended to remain as a single, inseparable unit throughout the life of the POS terminal 500. It is understood that the housing 530 can be formed separately from the circuitry 532 and that the circuitry 532 can be placed into and sealed within the housing 530 in a separate operation. It is also understood that the housing 530 can be oversized with respect to the circuitry 532 so that the circuitry 532 can be placed loosely into the housing 530. In another embodiment, the circuitry 532 can be selectively, sealingly enclosed within the housing 530, where the housing 530 includes a closure 534 removably attached to a body of the housing 530.

The housing 530 is fabricated from a suitably selected material that facilitates inhibiting the effect the material has on the signal being emitted from, for example, the transceiver 506 and/or the Wi-Fi component 516 and passing through the housing material. For example, and without limitation, suitable materials from which the housing 530 may be fabricated include polyethylene, propylene, isoprene, and butylenes (i.e., polyolefins). In other embodiments, the housing 530 is fabricated from any material that enables the POS terminal 500 to function as described herein.

In some embodiments, the POS terminal 500 may be connected to one or more peripheral devices (not shown). That is, the POS terminal 500 may communicate various data with one or more peripheral devices. For example, the POS terminal 500 may communicate with one or more peripheral devices through the Wi-Fi component 516, the transceiver 506, or other suitable means.

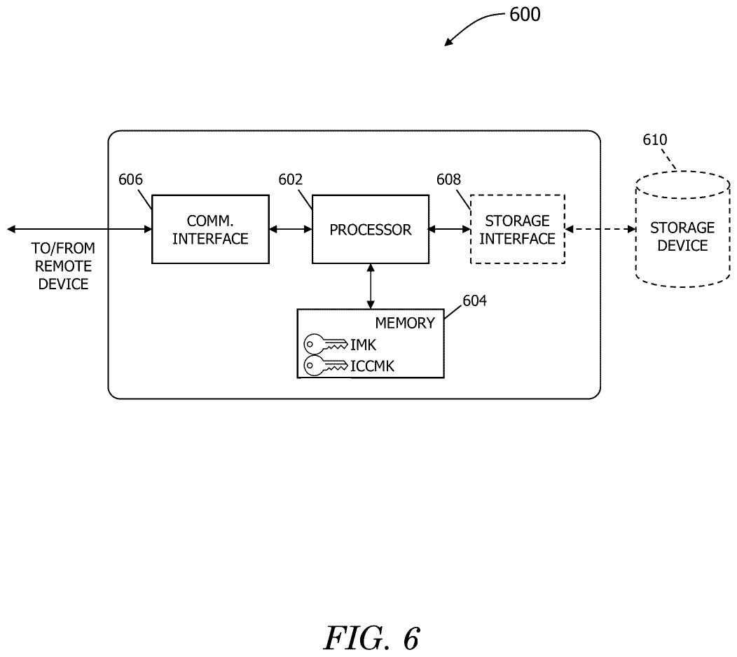

FIG. 6 is an example configuration of a server system 600, such as the issuer processor 210 (shown in FIG. 2). In the example embodiment, the server system 600 includes a processor 602 for executing instructions. The instructions may be stored in a memory area 604, for example. The processor 602 includes one or more processing units (e.g., in a multi-core configuration) for executing the instructions. The instructions may be executed within a variety of different operating systems on the server system 600, such as UNIX, LINUX, Microsoft Windows®, etc. More specifically, the instructions may cause various data manipulations on data stored in a storage device 610 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages). In the example embodiment, the processor 602 may be implemented as one or more cryptographic processors, as described above with respect to the user system 600.

The processor 602 is operatively coupled to a communication interface 606 such that the server system 600 can communicate with a remote device, such as another server system located at the interchange network 16 (shown in FIG. 1). For example, the communication interface 606 may receive communications originating from the POS terminal 32 via the Internet, as illustrated in FIG. 1.

The processor 602 is operatively coupled to the storage device 610. The storage device 610 is any computer-operated hardware suitable for storing and/or retrieving data. In some embodiments, the storage device 610 is integrated in the server system 600. In other embodiments, the storage device 610 is external to the server system 600 and is similar to the transaction card database 212 (shown in FIG. 2). For example, the server system 600 may include one or more hard disk drives as the storage device 610. In other embodiments, the storage device 610 is external to the server system 600 and may be accessed by a plurality of server systems 600. For example, the storage device 610 may include multiple storage units such as hard disks or solid-state disks in a redundant array of inexpensive disks (RAID) configuration. The storage device 610 may include a storage area network (SAN) and/or a network attached storage (NAS) system.

In some embodiments, the processor 602 is operatively coupled to the storage device 610 via a storage interface 608. The storage interface 608 is any component capable of providing the processor 602 with access to the storage device 610. The storage interface 608 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 602 with access to the storage device 610.

The memory area 604 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program. In embodiments where the server system 600 is an issuer processor, the memory area 604 may include a secure memory or secure memory are storing one or more cryptographic keys, such as an integrated circuit card (ICC) master key (or copy thereof) and an issuer master key (IMK).

### Exemplary Computer-Implemented Methods

### Deriving and Provisioning the ICC Master Key

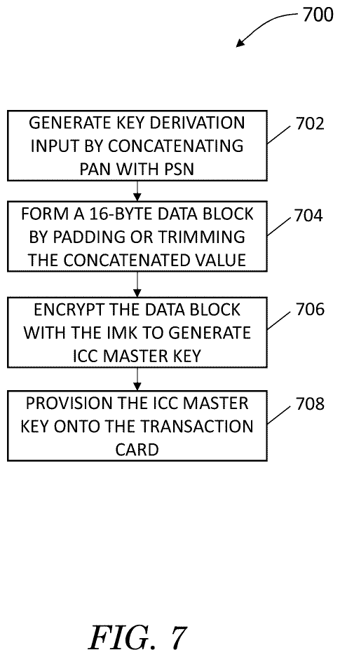

FIG. 7 is a flowchart illustrating an exemplary computer-implemented method 700 for deriving an integrated circuit card (ICC) master key from an issuer master key (IMK) and provisioning the derived ICC master key onto a payment card, such as the payment card 24 (shown in FIG. 3), in accordance with one or more embodiments of the present disclosure. The operations described herein may be performed in the order shown in FIG. 7 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 700 is described below, for ease of reference, as being executed by exemplary devices and components introduced with the embodiments illustrated in FIGS. 1-6. In one or more embodiments, the computer-implemented method 700 may be implemented by the issuer processor 210 (shown in FIG. 2). While operations within the computer-implemented method 700 are described below regarding the issuer processor 210, according to some aspects of the present invention, the computer-implemented method 700 may be implemented using other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

In the exemplary embodiment, at operation 702, the issuer processor 210 generates a unique key derivation input by generating a combined representation of the primary account number (PAN) of the payment card 24 and the corresponding PAN sequence number (PSN) to form a numeric sequence. The representation may include, but is not limited to, the PAN and PSN themselves, a concatenation of the PAN and PSN, a hash of the PAN and PSN, or any other decipherable, decryptable, or readable form or representation of the PAN and PSN. In an example, the PAN is concatenated from left to right with the PSN. If the PSN is not present, a ‘00’ byte is added in its place.

At operation 704, the issuer processor 210 generates a sixteen (16) byte data block from the combined representation (e.g., a concatenated value), forming a standardized intermediate data block. In the example, if the concatenated value is less than thirty-two (32) digits long, the issuer processor 210 pads the concatenated value to the left with hexadecimal zeros in order to obtain the 16-byte data block in numeric format. If the concatenated value is at least thirty-two (32) digits long, the issuer processor 210 uses the thirty-two (32) rightmost digits of the concatenated value in numeric format.

At operation 706, the issuer processor 210 generates the ICC master key 74 (shown in FIG. 4) from the resulting 16-byte data block. For example, the issuer processor 210 encrypts the resulting 16-byte data block using the IMK (stored, for example, in secure memory, such as memory 604 (shown in FIG. 6)) through a symmetric cryptographic algorithm, such as AES in Electronic Codebook mode (AES/ECB) or Triple DES (3DES), to generate the ICC master key 74.

Following the encryption, at operation 708, the issuer processor 210 securely provisions the derived ICC master key 74 onto the micromodule 42 of the transaction card 24. The provisioning is typically performed in a secure personalization environment managed by the issuer 18 or an authorized provisioning agent (not shown). Provisioning in a secure personalization environment ensures that the ICC master key 74 is securely stored within the memory device 58 of the transaction card 24, inaccessible to unauthorized entities. With the ICC master key 74 securely installed, the transaction card 24 can perform the cryptographic operations required for EMV-compliant payment transactions. For example, the transaction card 24 can generate application cryptograms such as authorization request cryptograms (ARQC), as described herein. Furthermore, as described herein, the transaction card 24 utilizes the ICC master key 74 to dynamically generate session keys, enabling secure creation of cryptographic transaction authentication data according to EMV cryptographic standards.

In an example of the method 700 described above, the transaction card 24 includes the following information:
PAN: 5472 2901 1612 7015
PSN: 00

The IMK associated with the issuer 18 is as follows:
IMK: FBFE672FDCADADADCBDADADFF7733E04

The issuer processor 210 creates ‘X’, which is a concatenation of the PAN and the PSN left to right, as follows:
X=547229011612701500

The resulting ‘X’ is less than thirty-two (32) digits. Therefore, the issuer processor 210 pads ‘X’ with seven (7) bytes of binary zeroes, to the left, to attain a 16-byte data block ‘Y’.
Y=00000000000000547229011612701500

The issuer processor 210 creates the ICC master key 74 (i.e., a ‘Z’ value) by AES/ECB encryption of ‘Y’ with the IMK, as follows:
Z=AES/ECB(IMK) [Y]
Z=BC1B97B60FA03D4BB23D292D536CFB0E

Thus, the derived issuer master key ‘Z’ is called the ICC master key 74, which is provisioned to the transaction card 24.

Secure Generation of Transaction Cryptogram Using a Cryptographic Data Element (CDE) with an Epoch Timestamp

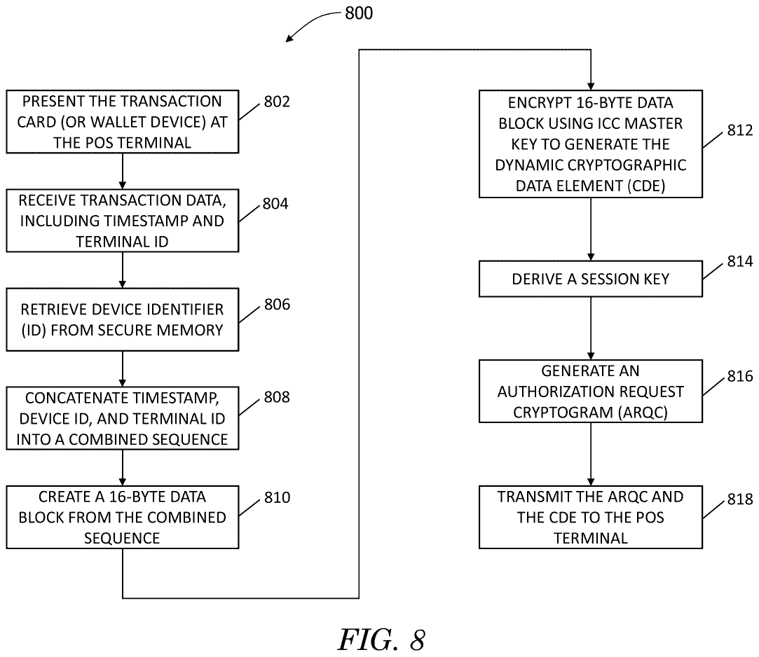

FIG. 8 is a flowchart illustrating an exemplary computer-implemented method 800 for performing a secure transaction between the transaction card 24 and the POS terminal 32 using the novel dynamic CDE to generate and securely transmit an application request cryptogram (ARQC) for transaction authorization, in accordance with one or more embodiments of the present disclosure. The operations described herein may be performed in the order shown in FIG. 8 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 800 is described below, for ease of reference, as being executed by exemplary devices and components introduced with the embodiments illustrated in FIGS. 1-6. In one or more embodiments, the computer-implemented method 800 may be implemented by the transaction card 24 (shown in FIG. 3). While operations within the computer-implemented method 800 are described below regarding the transaction card 24, according to some aspects of the present invention, the computer-implemented method 800 may be implemented using other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

At operation 802, the cardholder 22 presents the transaction card 24 (or a digital wallet-enabled device) to the POS terminal 32 to initiate a secure transaction. For example, the cardholder 22 may dip or tap the transaction card 24 at the POS terminal 32. Dipping of the transaction card 24 involves the cardholder 22 placing the card adjacent the chip reader 514, for example, by inserting the transaction card 24 into a slot (not shown) defined in the housing 530 of the POS terminal 32, such that the micromodule 42 (shown in FIG. 3) is in contact with the chip reader 514. Furthermore, tapping the transaction card 24 at the POS terminal 32 involves communication over NFC. This is accomplished by placing the transaction card 24 within a predetermined distance of the POS terminal 32, such that a magnetic field generated by the antenna 522 (shown in FIG. 5) can receive radio signals from the transaction card 24. When the transaction card 24 is dipped or tapped at the POS terminal 32, the POS terminal 32 activates the transaction card 24. The two (2) devices exchange various data required to perform the transaction, such as application selection data and supported transaction processing options and data objects.

At operation 804, the transaction card 24 receives transaction data from the POS terminal 32 for processing the transaction. For example, in the example embodiment, the POS terminal 32 transmits a request message to the transaction card 24 requesting ARQC generation. The request message includes an APDU (Application Protocol Data Unit) command (e.g., Generate AC), formatted per International Organization for Standardization (ISO) 7816 standard. The Generate AC command includes transaction-related data. In the exemplary embodiment, the POS terminal 32 transmits a unique terminal ID (e.g., Tag 9F1C or data element DE41) associated with the terminal along with an epoch timestamp to the transaction card 24. In addition, the POS terminal 32 may transmit additional transaction data (compliant with EMV standards) to the transaction card 24. The additional transaction data typically includes one or more of the following: a transaction amount (Tag 9F02), a transaction currency code (Tag 5F2A), a transaction date (Tag 9A), a transaction type (Tag 9C), an unpredictable number (Tag 9F37), a terminal country code (Tag 9F1A), and other relevant EMV data elements.

In an example embodiment, in response to the Generate AC command, the POS terminal 32 retrieves the epoch timestamp from the merchant processor 202 (shown in FIG. 2), which may function as a time server for providing accurate and synchronized time data. In other embodiments, the POS terminal 32 may retrieve the epoch timestamp from a network time server, such as one using the Network Time Protocol (NTP), or any other reliable source, such as a GPS-based clock or a secure local hardware clock. As used herein, epoch time (also referred to Unix time or POSIX time) or epoch timestamp represents a specific moment in time by counting how many seconds have passed since a fixed starting point, known as the epoch. The Unix epoch is midnight Coordinated Universal Time (UTC) on Jan. 1, 1970. By measuring time as a running total of elapsed seconds, epoch time avoids the complexities of time zones and daylight saving adjustments, making it simpler for computer systems to store, compare, and manipulate timestamps.

At operation 806, the transaction card retrieves the device ID associated with the transaction card 24. For example, the transaction card 24 may issue an internal command (such as a READ RECORD or GET DATA command) to access the EEPROM 68 and retrieve a unique hardware ID stored therein. Transaction cards typically have at least one unique ID used for, among other things, device recognition during payment or identification processes.

At operation 808, the transaction card 24 generates a combined representation of the (1) the epoch timestamp, (2) the device ID, and (3) the terminal ID to form a combined numeric sequence. The representation may include, but is not limited to, the epoch timestamp, device ID, and terminal ID themselves; a concatenation of the epoch timestamp, device ID, and terminal ID; a hash of the epoch timestamp, device ID, and terminal ID; or any other decipherable, decryptable, or readable form or representation of the epoch timestamp, device ID, and terminal ID. In an example, the transaction card 24 concatenates, from left to right, (1) the epoch timestamp, (2) the device ID, and (3) the terminal ID to form a combined numeric sequence.

At operation 810, the transaction card 24 generates a sixteen (16) byte data block from the combined value, forming a standardized intermediate data block. For example, if the combined value is less than thirty-two (32) digits long, the transaction card 24 pads the combined value to the right with hexadecimal zeros in order to obtain the 16-byte data block in numeric format. If the combined numeric sequence is at least thirty-two (32) digits long, the transaction card 24 uses the thirty-two (32) leftmost digits of the combined numeric sequence in numeric format for the 16-byte data block.

At operation 812, the transaction card 24 generates the dynamic CDE from the combined numeric sequence (i.e., the 16-byte data block). In particular, the transaction card 24 applies an AES (Advanced Encryption Standard) encryption to the combined numeric sequence using the ICC master key 74 stored in the memory device 58 of the micromodule 42. For example, in the preferred embodiment, the processor 60 (shown in FIG. 4) of the transaction card 24 engages the cryptographic coprocessor 62 (shown in FIG. 4) embedded within the micromodule 42. The cryptographic coprocessor 62 securely accesses the ICC master key 74 stored in the EEPROM 68. Using the AES/ECB mode cryptographic process, the cryptographic coprocessor 62 encrypts the concatenated 16-byte data block (comprising the epoch timestamp, device ID, terminal ID, and any needed padding) with the ICC master key 74. Specifically, the cryptographic coprocessor 62 takes the standardized data block as plaintext input, applies AES encryption, and outputs the uniquely encrypted dynamic CDE. The dynamic CDE ensures cryptographic uniqueness, facilitating protecting the transaction against replay and cloning attempts by embedding a time-sensitive component-the epoch timestamp-in conjunction with device-specific and terminal-specific identifiers.

At operation 814, the transaction card 24 generates a session-specific cryptographic key, or session master key (SMK). In the example, using the AES/ECB mode cryptographic process, the cryptographic coprocessor 62 encrypts the dynamic CDE with the ICC master key 74 to generate the SMK. Specifically, the cryptographic coprocessor 62 takes the dynamic CDE as plaintext input and applies AES/ECB mode encryption, which outputs a uniquely encrypted SMK.

At operation 816, the transaction card 24 generates an application request cryptogram (ARQC) for the transaction. For example, in the exemplary embodiment, the processor 60 concatenates, without padding, the transaction data (from data element DE55), including the following: the transaction amount (9F02); additional Amount (9F03); terminal country code (9F1A); terminal verification results (Tag 95); transaction currency code (Tag 5F2A); transaction date (Tag 9A); transaction type (Tag 9C); unpredictable number (Tag 9F37); application interchange profile (Tag 82); dynamic CDE (replacing the ATC); and card verification results (Tag 9F10), serially as a single hexadecimal string. The cryptographic coprocessor 62 encrypts the transaction data string by applying AES-based cipher-based Message Authentication Code (AES/CMAC) using the calculated SMK. The transaction card 24 selects only a portion of the resulting ciphertext as the ARQC. Specifically, the transaction card 24 selects the first eight (8) bytes of the resulting ciphertext as the ARQC.

At operation 818, the transaction card 24 transmits the calculated ARQC along with the EMV-compliant transaction data securely to the POS terminal 32. In the example embodiment, the transaction card 24 encapsulates the transaction data and ARQC in the EMV-compliant data element 55 (DE55). DE55 is a structured TLV (Tag-Length-Value) encoded set of EMV data elements conforming to EMV specifications. When the encapsulated transaction data (i.e., DE55) is transmitted from the transaction card 24 to the POS terminal 32 in response to the Generate AC request message, the response message follows the structured APDU format per ISO 7816-4.

As described above, referring to FIG. 2, the POS terminal 32 forwards the transaction information via the acquirer 14 and interchange network 16 (or payment processor) to the issuer 18 for validation and transaction authorization. Specifically, the POS terminal 32 decodes the DE55 TLV structure received from the transaction card 24. The POS terminal 32 assembles the data elements into an authorization request (e.g., ISO 8583 format MTI 0100 message) for transmission to the acquirer 14.

In an example of the method 800 described above, the transaction card 24 receives at least the following information from the POS terminal 32:
Epoch timestamp: 1736238423
Terminal ID: 457890

The transaction card 24 retrieves its device ID from memory, for example, as follows:
Device ID: 1234567890

The transaction card 24 creates the combined numeric sequence by concatenating the epoch timestamp, device ID, and terminal ID left to right, as follows:
Combined Numeric Sequence: 17362384231234567890457890

The resulting combined numeric sequence is less than thirty-two (32) digits. Therefore, the transaction card 24 pads the combined numeric sequence with six (6) bytes of binary zeroes to attain a 16-byte data block.
Padding: 000000
CDE input data block=17362384231234567890457890000000

The transaction card 24 creates the CDE by AES/ECB encryption of the CDE input data block with the ICC, as follows:
CDE=AES/ECB(ICC) [CDE input data block]
CDE=F2D60B899A0EF8C0E99FACC6E6754294

The transaction card 24 creates the SMK by AES/ECB encryption of the CDE with the ICC master key 74, as follows:
SMK=AES/ECB(ICC) [CDE]
SMK=98B1E09E613B5D6E01C8C848D78A61E6

The transaction card 24 creates the ARQC by AES/CMAC encryption of the concatenated transaction data (as described above) with the calculated SMK, as follows:
ARQC=AES/CMAC(SMK) [Transaction Data]
ARQC=first 8-bytes=706C9FE3CA6C3A23D7ABAE80FBEC7F4E

### Secure Validation of Transaction Cryptogram Using Epoch Timestamp Verification

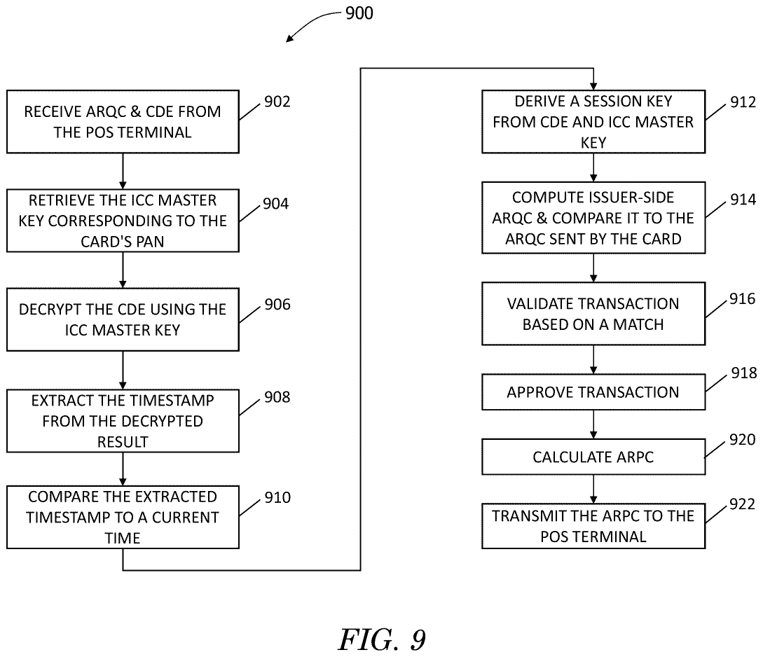

FIG. 9 is a flowchart illustrating an exemplary computer-implemented method 900 for securely validating a transaction by verifying the ARQC received from the transaction card 24 using the CDE, in accordance with one or more embodiments of the present disclosure. The operations described herein may be performed in the order shown in FIG. 9 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 900 is described below, for ease of reference, as being executed by exemplary devices and components introduced with the embodiments illustrated in FIGS. 1-6. In one or more embodiments, the computer-implemented method 900 may be implemented by the issuer processor 210 (shown in FIG. 2). While operations within the computer-implemented method 900 are described below regarding the issuer processor 210, according to some aspects of the present invention, the computer-implemented method 900 may be implemented using other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

At operation 902, the issuer processor 210 receives the transaction data (data element DE55) from the POS terminal 32, for example, via the acquirer 14 and the interchange network 16 (or payment processor). In the example embodiment, the transaction data includes, at least, the ARQC (Tag 9F26), the CDE (in a new data element tag, or alternatively, Tag 9F36), the unpredictable number (Tag 9F37), the transaction amount (Tag 9F02), the transaction date (Tag 9A), the transaction currency code (Tag 5F2A), the terminal verification results (Tag 95), the POS terminal ID (in Tag 9F1C or data element DE41), and any additional EMV-standard transaction details encapsulated within Data Element 55 (DE55).

At operation 904, the issuer processor 210 securely accesses the issuer-stored ICC master key corresponding to the ICC master key 74 provisioned onto the transaction card 24. For example, the issuer processor 210 retrieves a copy of the ICC master key 74 from database 212 (shown in FIG. 2) based on the transaction card PAN received in the transaction data.

At operation 906, using AES cryptography and the retrieved ICC master key, the issuer processor 210 decrypts the CDE received from the transaction card 24. Specifically, the issuer processor 210 applies the AES/ECB mode cryptographic process to decrypt the received CDE. The decrypted output reveals the original data, comprising the combined representation of the epoch timestamp, device ID, terminal ID, and any optional padding.

At operation 908, the issuer processor 210 extracts the epoch timestamp originally embedded by the transaction card 24 from the decrypted CDE. For example, the issuer processor 210 extracts the first ten (10) digits from the decrypted CDE, which, as described above, define the epoch timestamp received from the POS terminal 32.

At operation 910, the issuer processor 210 validates transaction freshness by comparing the extracted epoch timestamp to the issuer processor's real-time epoch time reading, obtained instantly just before performing the comparison. The issuer processor 210 may function as a time server for providing accurate and synchronized time data. In other embodiments, the issuer processor 210 may retrieve the epoch time from a network time server, such as one using the Network Time Protocol (NTP), or any other reliable source, such as a GPS-based clock or a secure local hardware clock. In the exemplary embodiment, the issuer 18 defines an acceptable freshness threshold value. The issuer processor 210 validates that the difference between the extracted epoch timestamp and the current epoch times falls within the permissible time range. In a preferred embodiment, the threshold value for transaction freshness validation is defined as five (5) seconds or less following the initial epoch timestamp extracted from the decrypted CDE. Alternatively, the threshold value may be any value determined to be acceptable by the issuer 18. Transactions with timestamps outside the predefined threshold value may be flagged for potential fraud and declined by the issuer processor 210.

At operation 912, the issuer processor 210 independently calculates a session-specific cryptographic key (SMK) by encrypting CDE extracted from the transaction data with the retrieved ICC master key. At operation 914, the issuer processor 210 generates an issuer-side ARQC using AES/CMAC, applying the calculated SMK to the concatenated transaction data received in DE55, which is identical to the data used by the transaction card 24 to create the ARQC transmitted to the issuer 18.

At operation 916, the issuer processor 210 compares the internally generated issuer-side ARQC with the ARQC received from the transaction card 24. If the two ARQCs match exactly, the issuer processor 210 validates the transaction; otherwise, the transaction is flagged as invalid or fraudulent. At operation 918, based on the successful validation freshness (i.e., timestamp within acceptable range) and cryptographic authenticity, the issuer processor 210 generates an authorization response (Approve or Decline).

At operation 920, the issuer processor 210 calculates an application response cryptogram (ARPC) using AES/CMAC by concatenating the validated ARQC with an issuer-defined response code and additional padding as defined by EMV standards, encrypted with the calculated SMK. At operation 922, the issuer processor 210 securely transmits an authorization response message with ARPC back through the interchange network 16 and acquirer 14 to the POS terminal 32 (e.g., via the merchant 12).

By employing the dynamic CDE containing an epoch timestamp, a device ID (associated with the payment device), and terminal ID (associated with the POS terminal), the methods and systems described herein provide substantial performance and infrastructure advantages over the traditional application transaction counter (ATC) used in current payment transactions. Specifically, the disclosed invention described herein eliminates the need for maintaining, retrieving, and managing historical ATC records in persistent storage, significantly reducing latency in transaction processing, minimizing infrastructure costs, and lowering database overhead.

### Additional Considerations

In this description, references to “one or more embodiments,” “an embodiment,” or “embodiments” mean that the feature or features being referred to are included in at least one embodiment of the technology. Separate references to “one or more embodiments,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this application, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the term “database” includes either a body of data, a relational database management system (RDBMS), or both. As used herein, a database includes, for example, and without limitation, a collection of data including hierarchical databases, relational databases, flat file databases, object-relational databases, object-oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL® (PostgreSQL is a registered trademark of PostgreSQL Community Association of Canada, Toronto, Canada). However, any database may be used that enables the systems and methods to operate as described herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor includes a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

1. A computer-implemented method performed by a specialized cryptographic payment device for generating an application request cryptogram (ARQC) for use in a transaction, the payment device including a cryptographic coprocessor and a secure memory storing at least a master key and a device identifier uniquely identifying the payment device, the method comprising:
receiving, from a point-of-sale (POS) terminal, a request message requesting generation of the ARQC, the request message including:
transaction data associated with the transaction,
a timestamp, and
a terminal identifier associated with the POS terminal and uniquely identifying the POS terminal;
retrieving, from the secure memory, the device identifier;
forming a data block by generating a representation of the timestamp, the terminal identifier, and the device identifier;
encrypting, by the cryptographic coprocessor, the data block using the master key, thereby producing a cryptographic data element (CDE);
deriving a session key from the CDE;
generating the ARQC, including:
forming a transaction data string by generating a representation of the transaction data and the CDE, and
encrypting, by the cryptographic coprocessor, the transaction data string using the session key, the ARQC being generated without incrementing an application transaction counter (ATC) of the payment device; and
transmitting the ARQC and the CDE to the POS terminal for transmission to an issuer server associated with the payment device for validation.

2. The method of claim 1, further comprising:
determining that the data block is shorter than a predetermined length, and
based on the determination, padding the data block with one or more zeros, extending the data block to the predetermined length.

3. The method of claim 1,
the step of generating the ARQC further including selecting only a portion of the encrypted transaction data string as the ARQC.

4. The method of claim 1,
the step of encrypting the data block using the master key comprising using an advanced encryption standard (AES) cryptographic algorithm in electronic codebook (ECB) mode.

5. The method of claim 1, the timestamp comprising a Unix epoch timestamp representing a number of seconds elapsed since 00:00:00 Coordinated Universal Time (UTC) on Jan. 1, 1970.

6. The method of claim 1,
the step of deriving a session key from the CDE comprising encrypting the CDE using the master key stored in the payment device.

7. The method of claim 6,
the step of encrypting the CDE using the master key comprising using an AES cryptographic algorithm in ECB mode.

8. The method of claim 1,
the step of receiving the request message comprising receiving an Application Protocol Data Unit (APDU) command formatted according to at least one International Organization for Standardization (ISO) 7816 standard.

9. The method of claim 8, further comprising:
encapsulating the ARQC and the CDE into a tag-length-value (TLV) data format conforming to EMV specifications, and
encoding the TLV formatted ARQC and CDE into a response APDU message,
the step of transmitting the ARQC and the CDE to the POS terminal including transmitting the response APDU message to the POS terminal.

10. The method of claim 1,
the step of encrypting the transaction data string using the session key comprising applying an AES cipher-based message authentication code (AES/CMAC) process to the transaction data string using the session key.

11. A specialized cryptographic payment device for generating an application request cryptogram (ARQC) for use in a transaction, the payment device comprising:
a first processor;
a second cryptographic coprocessor;
a first secure memory storing a master key and a device identifier uniquely identifying the payment device; and
a second program memory storing computer executable instructions thereon that when executed by the first processor, cause the first processor to:
receive, from a point-of-sale (POS) terminal, a request message requesting generation of the ARQC, the request message including:
transaction data associated with the transaction,
a timestamp, and
a terminal identifier associated with the POS terminal and uniquely identifying the POS terminal,
retrieve the device identifier from the first secure memory,
form a data block by generating a representation of the timestamp, the terminal identifier, and the device identifier,
engage the second cryptographic coprocessor,
encrypt, via the second cryptographic coprocessor, the data block with the master key, thereby producing a cryptographic data element (CDE),
derive a session key from the CDE,
generate the ARQC, including:
forming a transaction data string by generating a representation of the transaction data and the CDE, and
encrypting, via the second cryptographic coprocessor, the transaction data string using the session key, the ARQC being generated without incrementing an application transaction counter (ATC) of the payment device, and
transmit the ARQC and the CDE from the payment device to the POS terminal for transmission to an issuer server associated with the payment device for validation.

12. The payment device of claim 11, the computer executable instructions causing the first processor to:
determine that the data block is shorter than a predetermined length, and
based on the determination, pad the data block with one or more zeros, extending the data block to the predetermined length.

13. The payment device of claim 11,
the computer executable instructions causing the first processor, as part of the step of generating the ARQC, to select only a portion of the encrypted transaction data string as the ARQC.

14. The payment device of claim 11,
the computer executable instructions causing the first processor, as part of the step of encrypting the data block using the master key, to use an advanced encryption standard (AES) cryptographic algorithm in electronic codebook (ECB) mode.

15. The payment device of claim 11,
the timestamp comprising a Unix epoch timestamp representing a number of seconds elapsed since 00:00:00 Coordinated Universal Time (UTC) on Jan. 1, 1970.

16. The payment device of claim 11,
the computer executable instructions causing the first processor, as part of the step of deriving the session key, to encrypt the CDE using the master key stored in the payment device.

17. The payment device of claim 16,
the computer executable instructions causing the first processor, as part of the step of encrypting the CDE, to use an AES cryptographic algorithm in ECB mode.

18. The payment device of claim 11,
the computer executable instructions causing the first processor, as part of the step of receiving the request message, to receive an Application Protocol Data Unit (APDU) command formatted according to at least one International Organization for Standardization (ISO) 7816 standard.

19. The payment device of claim 18,
the computer executable instructions causing the first processor to:
encapsulate the ARQC and the CDE into a tag-length-value (TLV) data format conforming to EMV specifications, and
encode the TLV formatted ARQC and CDE into a response APDU message,
the computer executable instructions causing the first processor, as part of the step of transmitting the ARQC and the CDE to the POS terminal, to transmit the response APDU message to the POS terminal.

20. The payment device of claim 11,
the computer executable instructions causing the first processor, as part of the step of encrypting the transaction data string using the session key, to apply an AES cipher-based message authentication code (AES/CMAC) process to the transaction data string using the session key.
